(19) United States
(12) Patent Application Publication
(10) Pub. No.: US 2021/0146637 A1
(43) Pub. Date: May 20, 2021

(54) METHOD FOR FORMING UNITARY ANTIBALLISTIC PANELS

(71) Applicant: MISSINGEN SERVICES AS, Kråkerøy (NO)

(72) Inventors: Tom JONASSEN, Manstad (NO); Pål Francis HANSEN, Vesteroy (NO)

(73) Assignee: MISSINGEN SERVICES AS, Kråkerøy (NO)

(21) Appl. No.: 17/081,803

(22) Filed: Oct. 27, 2020

(30) Foreign Application Priority Data
Oct. 28, 2019 (NO) 20191288

(51) Int. Cl. B29C 65/48; F41H 5/04; B29C 65/00

(52) U.S. Cl. CPC B29C 65/48; F41H 5/0428; B29K 2309/08; B29C 66/721; B29C 66/7461

(57) ABSTRACT

A method for forming an antiballistic panel includes selecting a largest ceramic plate, i.e. one with a widest circumference, from a batch of ceramic plates; forming a number of transparent rear covers with the shape of said largest ceramic plate; forming a batch of antiballistic panels each based on a single ceramic plate, wherein each antiballistic panel is vacuum baked from the following: a fibre reinforced composite layer which at least covers a front face of the ceramic plate; a trauma reducing fibre reinforced composite layer on a rear face of the ceramic plate; a binder cloth on the trauma reducing composite layer's rear face; an expanding, gluing foam on said binder cloth; mounting a transparent back cover onto the gluing foam to cover an entire circumference of the vacuum baked antiballistic panels; compression of the antiballistic panel now including the rear cover; and hardening of the foam.

### INTRODUCTION

The invention relates to an antiballistic panel (0). The invention is a method for forming an antiballistic panel (0).

### DISADVANTAGES OF THE BACKGROUND ART

One always manufacture a batch of antiballistic ceramic plates (1), they may not be made one by one due to economical reasons; they should e.g. be sintered all together in a large furnace. Those plates (1) rarely get an entirely equal shape because the sintering process and the manufacture in general of the ceramic plates (1) result in small differences which are hard to avoid. This is a known problem in the manufacture of ceramics.

It is a practical and safety concern that antiballistic panels are of slightly unequal shape. This makes storage, transport and use require special adaptations for avoiding slack. Special adaptations are expensive, and one may not easily move one antiballistic panel from one vest to another if one should desire to do so.

### FIGURE CAPTIONS

FIG. 1 is a section along a ceramic antiballistic plate (1), and section of a largest ceramic plate (1max) of a batch of such antiballistic ceramic plates (1) used as a plug for a back cover (9max), e.g. a polycarbonate back cover, according to the invention. L1 is a measure across the ceramic plate (1). (12max) is the rear face of the largest ceramic plate (1max). (9max) is a standardized, transparent polycarbonate rear cover formed as a mould of the rear face (12max) of the largest ceramic plate (1max) or on a plug (12P) shaped as the largest ceramic plate (12max). (1) is a ceramic plate (1) from a batch. (1max) is the largest ceramix plate (1max) in the batch of several slightly un-equal ceramic plates: (L1′) is a measure across the largest ceramic plate (1max).

FIG. 2 is a section along the transparent polycarbonate back cover according to the invention, with an internally arranged label (option).

FIG. 3 shows a section through an almost finished antiballistic panel (0′) with a concave front of an antiballistic plate (1) covered by a thin layer of fiber reinforced composite layer (2), and whereon the trauma reducing fibre reinforced composite layer on the rear surface (12) of the ceramic plate has been applied with an expanding glue foam, and whereupon is laid a standardized transparent cover (9max) according to the invention. After this, the entire layup is put under pressure while the foam expands and hardens. Thus the foam may intrude entirely and spread out between the trauma reducing layer (3) and the back cover (9max). (11) is the front face (11) of the ceramic plate (1); joint (4) with the transparent composite layer (2). (25) i the rear face (25) of (the transparent) composite layer (2). (2, 26, 27) are (transparent) fibre reinforced composite layer (vertically exaggerated thickness). (12) is the rear face (12) of the ceramic plate (1). (91) is an internally arranged label. (92) is a binder cloth. (93) is an expanding gluing foam, e.g. expanding sealing foam applied to the binder cloth or in [the back cover] (9max). (9max) is a standardized polycarbonate rear cover. (3) is a trauma reducing fibre reinforced composite layer on the rear face (12) of the ceramic plate (1), e.g. aramide cloths in matrix.

FIG. 4 shows a section through an antiballistic panel (0) with a concave front of an antiballistic plate (1) covered by a thin layer of a fibre reinforced composite layer (2), and wherein the trauma reducing fibre reinforced composite layer at the rear face (12) of the ceramic plate is covered by a protective, standardized transparent cover (9max) according to the invention. Also here is shown an internal label. FIG. 4 is a section along the antiballistic plate according to the invention, with a rear cover after mounting, according to the invention. (11) is the front face (11) of the ceramic plate (1); joint (4) with the transparent composite layer (2). (25) i the rear face (25) of (the transparent) composite layer (2). (2) is a transparent fibre reinforced composite layer (vertically exaggerated thickness). (12) is the rear face (12) of the ceramic plate (1). (91) is an internally arranged label. (92) is a binder cloth. (93) is an expanding gluing foam, hardened. (9max) is a standardized polycarbonate rear cover. (3) is a trauma reducing fibre reinforced composite layer on the rear face (12) of the ceramic plate (1), e.g. aramide cloths in matrix.

FIG. 5 shows a finished antiballistic panel (0) with a concave rear face with a transparent polycarbonate cover (9max) and with a sealed rim, and with a ceramic antiballistic plate (1). FIG. 5 is a perspective image of an antiballistic panel according to an embodiment of the invention, with its transparent back cover and with a baked-in label.

FIG. 6a shows a rear cover outer face.

FIG. 6b shows a rear cover inner face.

FIG. 7a shows a lay-up rear face after vacuum baking, with binder cloth integrated. It also shows a trauma reducing fibre reinforced composite layer on the rear face (12) of the ceramic plate (12) of the ceramic plate (1), with a binder cloth integrated as a rear layer, e.g. aramide cloths in matrix.

FIG. 7b shows a lay-up front face after vacuum baking. It also shows a transparent fibre reinforced composite layer (2).

FIG. 8a shows a rear cover (transparent outer face) of an assembled antiballistic panel.

FIG. 8b shows a front face of an assembled antiballistic panel, ref. FIG. 5.

FIG. 9a shows an inner face of a soft front cover, a removable protective cover (5).

FIG. 9b shows a front face of a soft front cover.

FIG. 10 illustrates a section of a protective cover (5), a removable protective cover (5).

### DESCRIPTION OF EMBODIMENTS OF THE INVENTION

It is a practical and safety concern that antiballistic panels are of slightly unequal shape. This makes storage, transport and use require special adaptations for avoiding slack. Special adaptations are expensive, and one may not easily move one antiballistic panel from one vest to another if one should desire to do so.

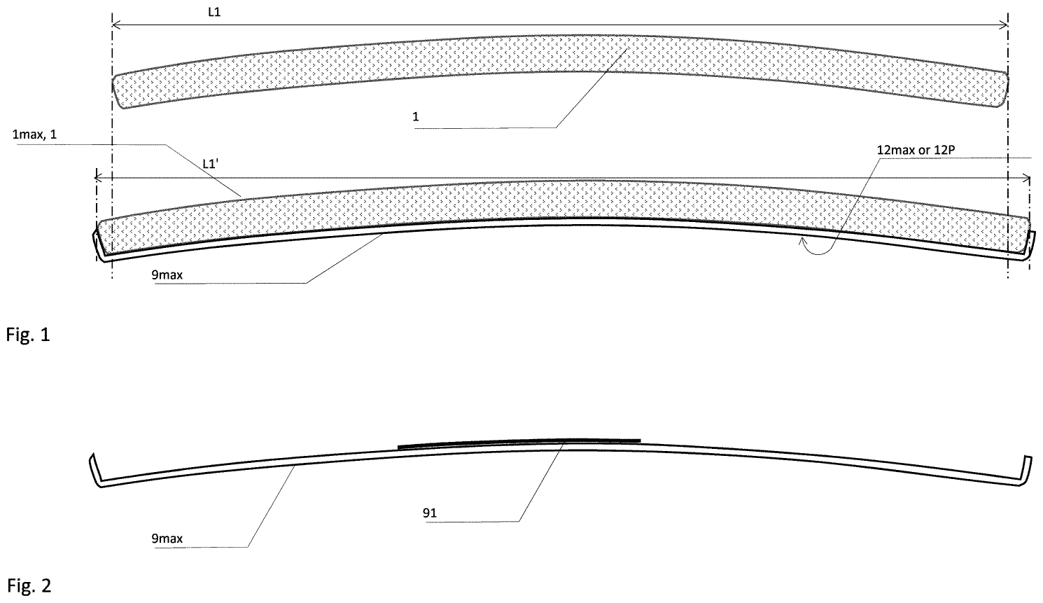

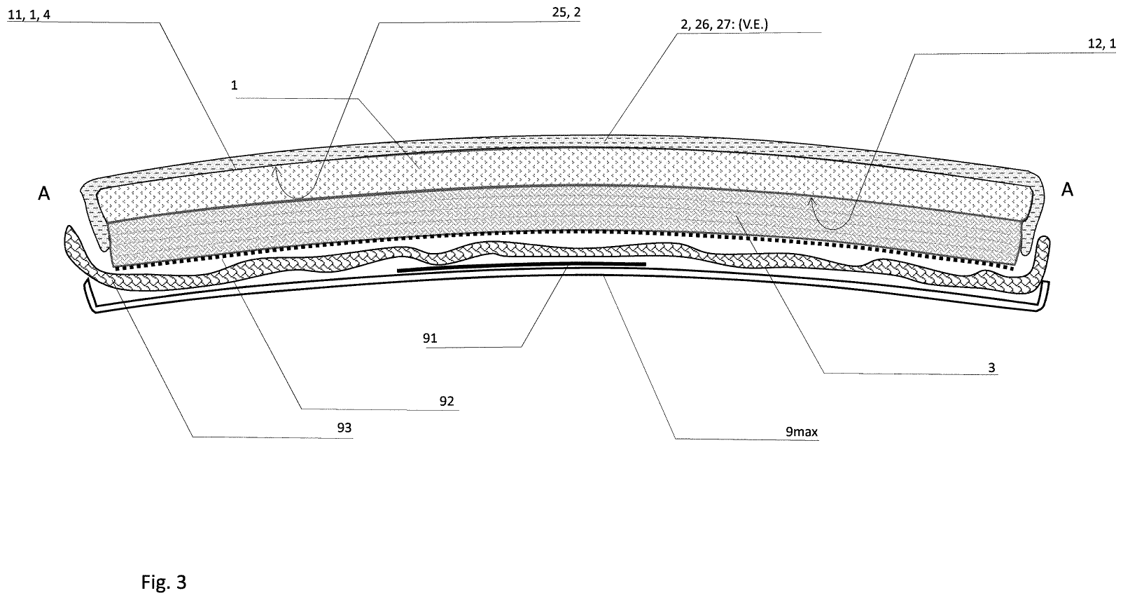

The invention relates to an antiballistic panel (0). The invention is a method for forming an antiballistic panel (0) comprising the following steps:
One provides a batch of antiballistic ceramic plates (1). Those are rarely of entirely equal shape because the sintering process and the other steps of manufacture of the ceramic plates (1) incurs small deviations which are hard to avoid. This is a known problem in the manufacture of ceramics. One then makes a selection of the largest ceramic plate (1max), i.e. the plate with widest circumference, from the batch of ceramic plates (1), see FIG. 1.
Thereafter, one forms a number of transparent rear covers (9max) with the shape of the largest ceramic plate (1max), please see FIG. 1, wherein the number corresponds to at least the number in the batch of ceramic plates (1);
One then forms a batch of antiballistic panels (0′) based on each single ceramic plate (1), wherein each antiballistic panel (0′) is vacuum baked from the following:
   a fibre reinforced composite layer (2) which at least covers a front face (11) of the ceramic plate (1);
   a trauma reducing fibre reinforced composite layer (3) on a rear face (12) of the ceramic plate (1), e.g. aramide cloths in matrix;
   a binder cloth (92) on the trauma reducing composite layer's (3) rear face;
application of an expanding, gluing foam (93) on said binder cloth (92), please see FIG. 3;
mounting a transparent back cover (9max) onto the gluing foam (93) so as for it to cover the entire circumference of the vacuum baked antiballistic panel's (0′), please see FIG. 3;
compression of the antiballistic panel (0) now comprising the rear cover (9max), please see FIG. 4, and hardening of the foam (93).

One thus has formed a batch with antiballistic panels with equal outer shape corresponding to the outer shape of the transparent rear cover (9max), please see FIG. 4.

In an embodiment of the invention one may, ahead of the mounting of the transparent back cover (9max) apply a label on the inner surface of the transparent bac cover (9max), please see FIG. 2. This makes the antiballistic panel “tamper free”, i.e. that in order to change the label, one has to penetrate the transparent rear cover for subsequently to create a counterfeit label. This is difficult and labour intensive and makes counterfeiting difficult. Thus the bearer of the antiballistic panel is rather sure that he stands carrying a counterfeit product in his hands. The label may contain information on manufacturer, batch date, certification, and type.

In an embodiment one may crop redundant foam outside the rim of the rear cover (9max) and the ceramic plate (1). This is done to avoid having an uneven rim on the antiballistic panel.

In an embodiment, the transparent rear cover may be applied with black colour or other opaque colour after application of the label. The opaque layer may protect the trauma reducing layer (3) against sunlight, or it may constitute a camouflage of the antiballistic panel; the trauma reducing layer is usually yellowish and light. Likewise, it is also an advantage if the fibre reinforcing composite layer (2) on the front face, is dark or in camouflage colours.

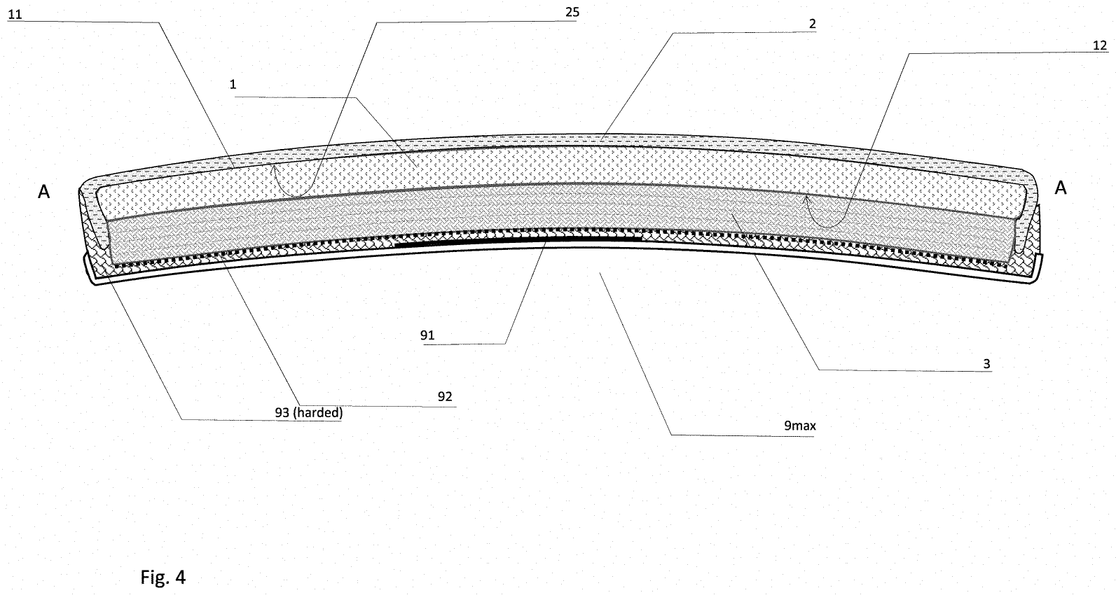

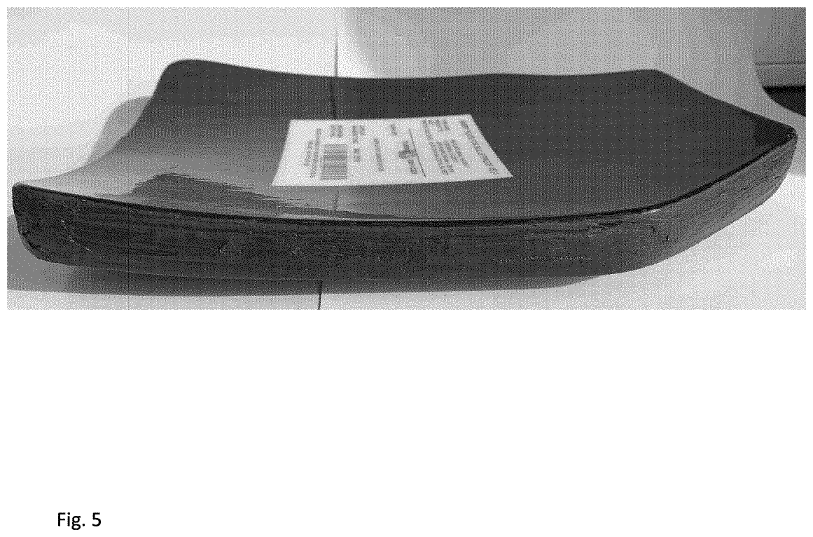

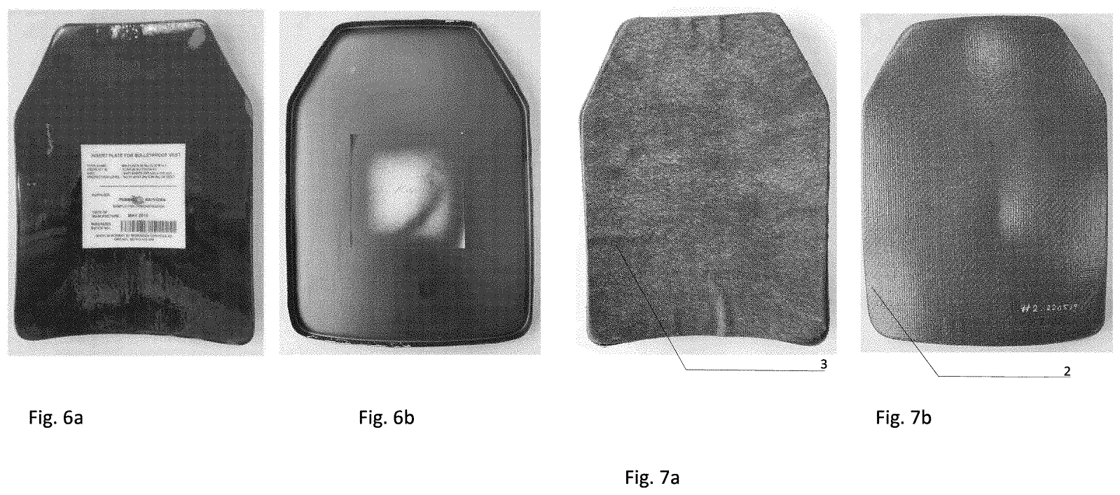

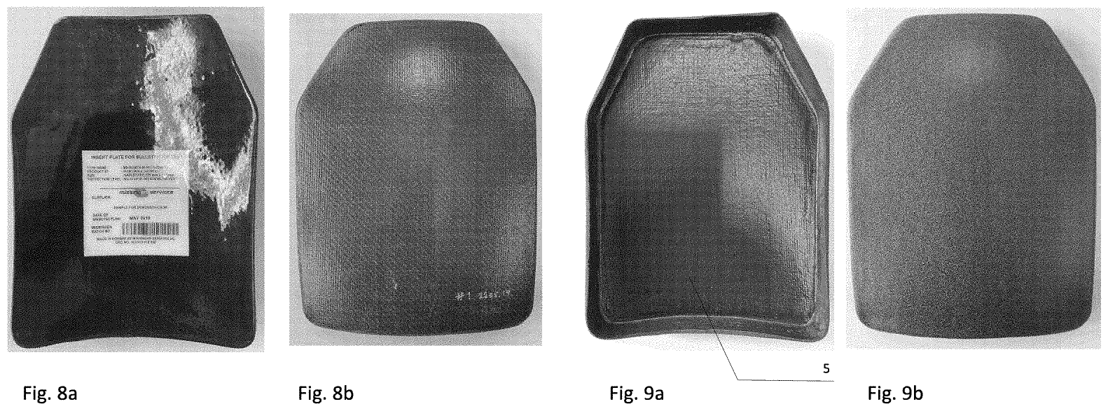

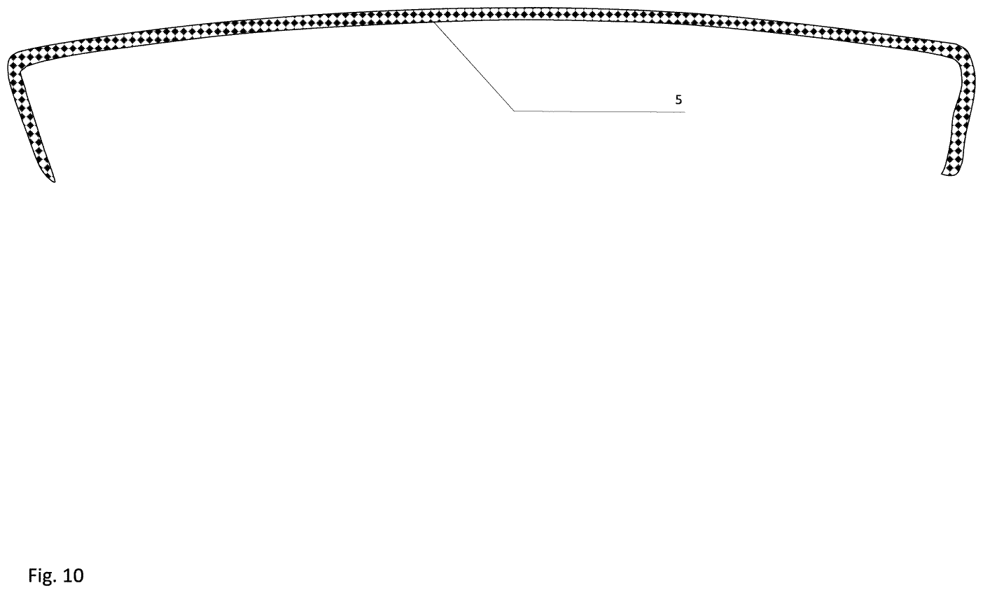

In an embodiment of the invention one may seal the otherwise exposed rim of the antiballistic panel (0) with a sealing flexible material, e.g. rubber. Please see FIG. 5. Thus one prevents intrusion of humidity and chemicals and particles into the antiballistic panel. It is particularly important to prevent intrusion of water and other spills into the trauma reducing layer (3), which otherwise could essentially could have changed the density and properties in a way that it would not function as trauma reducing, and thus too easily may allow projectiles through.

In an embodiment of the invention the ceramic plate (1) is formed mainly of Boron Carbide B₄C. This is heavy and has high hardness and has very good antiballistic properties. Other ceramic materials may be used.

In an embodiment of the invention a plastic matrix (26) in the transparent fibre reinforced surface composite layer (2) is a polyester or a PET [Polyethylene terephtalate]

In an embodiment of the invention the reinforcing fibres (27) comprise glass fibre and which is seized with a means for making bonding between the reinforcing fibres (27) and the plastic matrix (26).

Those embodiments provide a rugged composite protection of the ceramic plate (1) which also provides a good adhesion integrity in case the ceramic plate (1) should become hit by gunfire and partially fragmented, and prevents delamination upon beating or under gunfire.

1. A method for forming an antiballistic panel comprising the following steps:
selecting a largest ceramic plate from a batch of ceramic plates;
forming a number of transparent rear covers with the shape of said largest ceramic plate, wherein said number of transparent rear covers corresponds to at least a number of ceramic plates in the batch of ceramic plates;
forming a batch of antiballistic panels, each based on a single ceramic plate, wherein each antiballistic panel is vacuum baked from the following:
a fibre reinforced composite layer which at least covers a front face of the ceramic plate;
a trauma reducing fibre reinforced composite layer on a rear face of the ceramic plate; and
a binder cloth on a rear face of the trauma reducing fibre reinforced composite layer;
applying an expanding, gluing foam on said binder cloth;
mounting a transparent back cover onto the gluing foam to cover an entire circumference of the vacuum baked antiballistic panel; and
compressing the antiballistic panel now comprising the rear cover, and hardening of the foam.

2. The method of claim 1, further comprising the step of applying a label to the inner face of the transparent rear cover before the application of the transparent rear cover.

3. The method according to claim 1, further comprising the step of cropping of redundant foam outside a rim of the rear cover and the ceramic plate.

4. The method according to claim 2, further comprising the step of cropping of redundant foam outside a rim of the rear cover and the ceramic plate.

5. The method according to claim 1, further comprising the step of sealing off an exposed rim of the antiballistic panel with a sealing, flexible material.

6. The method according to claim 2, further comprising the step of sealing off an exposed rim of the antiballistic panel with a sealing, flexible material.

7. The method according to claim 3, further comprising the step of sealing off an exposed rim of the antiballistic panel with a sealing, flexible material.

8. The method according to claim 4, further comprising the step of sealing off an exposed rim of the antiballistic panel with a sealing, flexible material.

9. The method according to claim 1, wherein the ceramic plate is formed mainly of Boron Carbide B₄C.

10. The method according to claim 2, wherein the ceramic plate is formed mainly of Boron Carbide B₄C.

11. The method according to claim 4, wherein the ceramic plate is formed mainly of Boron Carbide B₄C.

12. The method according to claim 8, wherein the ceramic plate is formed mainly of Boron Carbide B₄C.

13. The method according to claim 1, wherein a plastic matrix in the transparent fibre reinforced surface composite layer is a polyester or a PET.

14. The method according to claim 2, wherein a plastic matrix in the transparent fibre reinforced surface composite layer is a polyester or a PET.

15. The method according to claim 3, wherein a plastic matrix in the transparent fibre reinforced surface composite layer is a polyester or a PET.

16. The method according to claim 8, wherein a plastic matrix in the transparent fibre reinforced surface composite layer is a polyester or a PET.

17. The method according to claim 12, wherein a plastic matrix in the transparent fibre reinforced surface composite layer is a polyester or a PET.

18. The method according to claim 1, wherein the reinforcing fibres comprise glass fibre and which is seized with a means for making bonding between the reinforcing fibres and the plastic matrix.

19. The method according to claim 13, wherein the reinforcing fibres comprise glass fibre and which is seized with a means for making bonding between the reinforcing fibres and the plastic matrix.

20. The method according to claim 17, wherein the reinforcing fibres comprise glass fibre and which is seized with a means for making bonding between the reinforcing fibres and the plastic matrix.
